(19) United States
(12) Patent Application Publication
(10) Pub. No.: US 2017/0022734 A1
(43) Pub. Date: Jan. 26, 2017

(54) Token Key Locker

(71) Applicant: Thomas Callahan, III, Lubbock, TX (US)

(72) Inventor: Thomas Callahan, III, Lubbock, TX (US)

(21) Appl. No.: 15/283,377

(22) Filed: Oct. 1, 2016

Related U.S. Application Data
(60) Provisional application No. 62/360,448, filed on Jul. 10, 2016.

(51) Int. Cl. E05B 35/12; E05B 65/02; E05B 35/08; E05B 65/00

(52) U.S. Cl. CPC E05B 35/12; E05B 65/0075; E05B 65/025; E05B 35/086

(57) ABSTRACT

Currently, people at a public or private location wishing to store their valuables have limited options. They may use a token locker where a coin-shaped token is inserted into and retained by the locking device, allowing the release of a locking key. They may use a similar electronic version of the token locker. In some cases, they may have to bring their own lock or even a separate private locker to store their valuables. The standard token requires a new token to be inserted each time the door is opened and leaves the location unable to track the duration of use. Electronic devices can be expensive and require a source of electricity. Bringing a lock or entire lock box is cumbersome.

The solution is a process whereby a universal key is used in place of a token. This universal key, as a token would do, releases a unique locking key from the locker. The universal key, labeled for tracking, is borrowed for use at the location. It is used in place of a token any number of times and then is returned after usage is completed. This process relies on a unique mechanism within each locker that handles the key that is used in place of a token and the key that secures the locker. The invention also allows an inexpensive method for a location to keep track of who has rented which locker and allows tracking of how long it is used. Furthermore, the user has the advantage of being able to reuse the universal key in different lockers prior to returning it. This advancement on the ordinary token locker creates clear advantages over current methods and can create employment opportunity that adds a human touch in the handling of the delivery and return of the universal key being used in place of a token.

The access method starts with the user wishing to use a locker obtaining a universal key used in place of a token, herein referred to as the token key, from an official or supplying machine at the location. The token key fits into and thereby allows the use of any number of lockers or lock boxes at a location by freeing the second unique key, which fits only that particular locker and herein is referred to as the locking key. The locking key is what actually secures the locker but may only be removed with the token key in place. This access method requires a mechanism within each locker or lock box that allows only one of the two keys to be removed at a time. Only with the locking key returned may the person using that locker remove the token key. The user may then continue using the token key at the same or other lockers, or return it to the official or machine to complete the use of the access token key.

The mechanism that allows this is comprised of two cam type cylinder locks where the plugs of the cylinders are interconnected in an offset position to keep one of the two keys retained by only allowing one keyhole at a time to line up for key removal. This is accomplished by an interlocking mechanism that maintains a relative offset position of the cams of the two locks. Any time one keyhole is lined up, the key keyhole on the other lock will be out of alignment. Thus, the user must replace one key to remove the other. This function is what makes this locker access method possible.

To summarize, the locker access process described above relies on a mechanism whereby a non-unique key is used in place of a token in order to free a unique locking key for a particular locker. The user obtains a universal token key which allows the use of multiple lockers at a location and may be reused prior to returning it. Once finished, the user returns this universal access token key to the official or to a machine, making it possible to keep track of who is using which locker and for how long. Therefor these features create clear advantages over current locker access methods and make use of a novel two key method and mechanism.

### DESCRIPTION OF THE FIGURES OF THE DRAWINGS

FIG. 1 shows an example of the lockable container with the lid detached for illustrative purposes. Part 6 is the unique locking mechanism which releases only one key at a time and is explained in further detail in FIGS. 6 through 9. Part 1 is the token key. Part 3 is the locking key. Part 6 is the locking mechanism. Part 7 is the latch used by the locking mechanism to secure the lid. Part 5 is the lid. Part 8 is the container box.

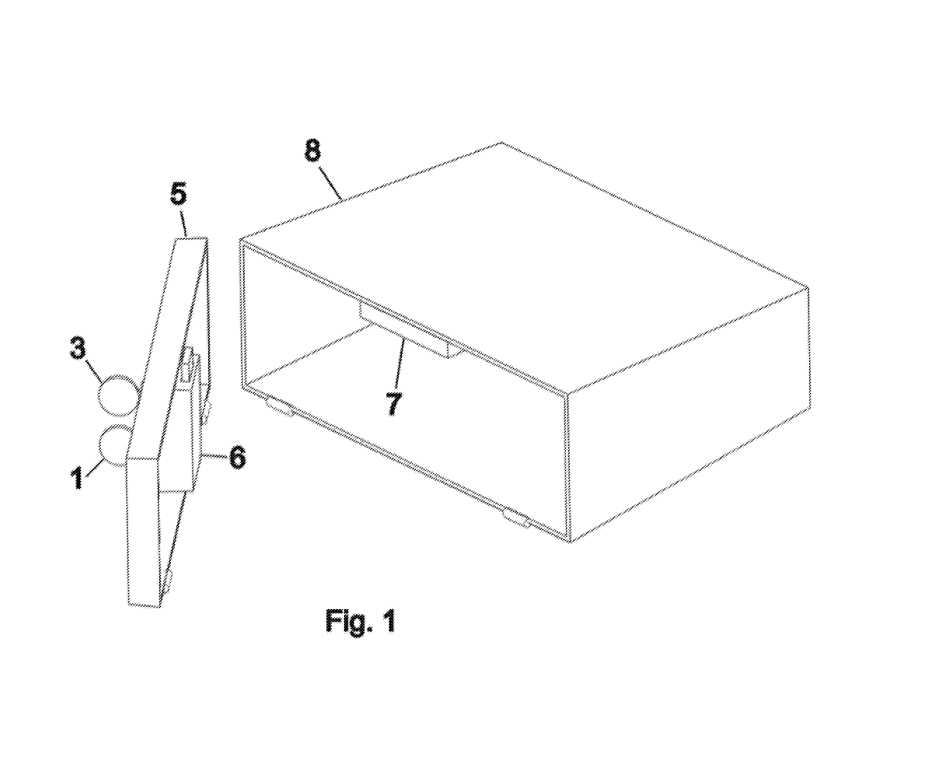

FIG. 2 shows an example of an assembled lockable container in the available condition. Part 1 is the token key. Part 2 is the token key mechanism, ready for a token key. Part 3 is the locking key, retained in place. Part 4 is the locking key mechanism. Part 5 is the lid. Part 8 is the container box.

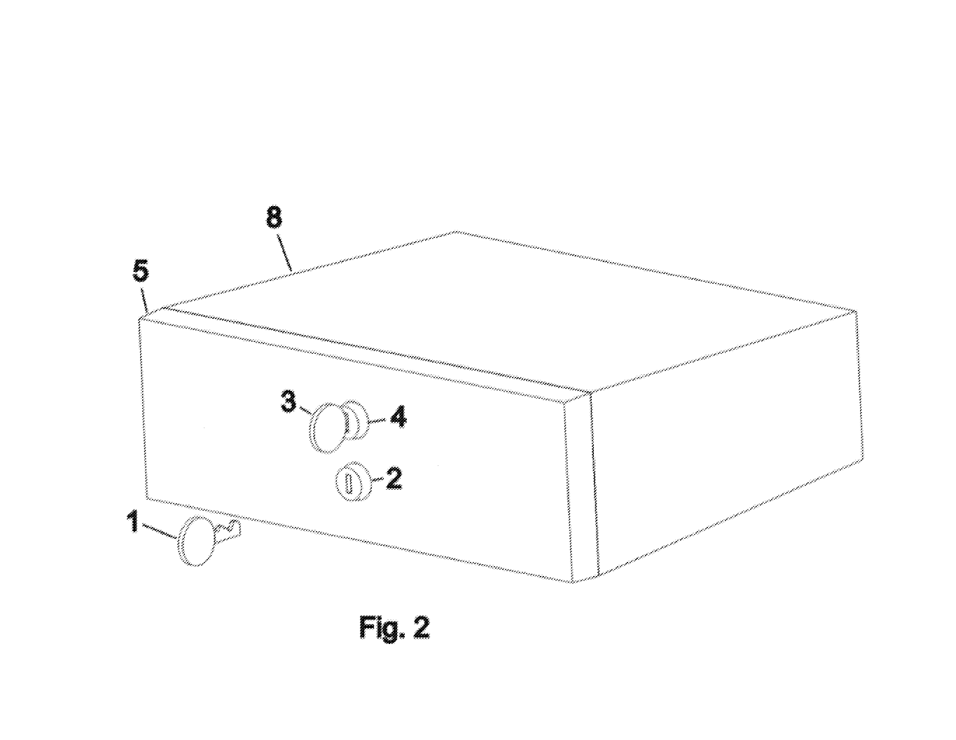

FIG. 3 shows an example of a lockable container made useable by having both the locking key and token key in place. In this condition, either key may be removed. The token key may be removed to return for completion of the usage or the locking key may be removed to secure the lockable container. Part 1 is the token key. Part 2 is the token key mechanism. Part 3 is the locking key. Part 4 is the locking key mechanism. Part 5 is the lid. Part 8 is the container box.

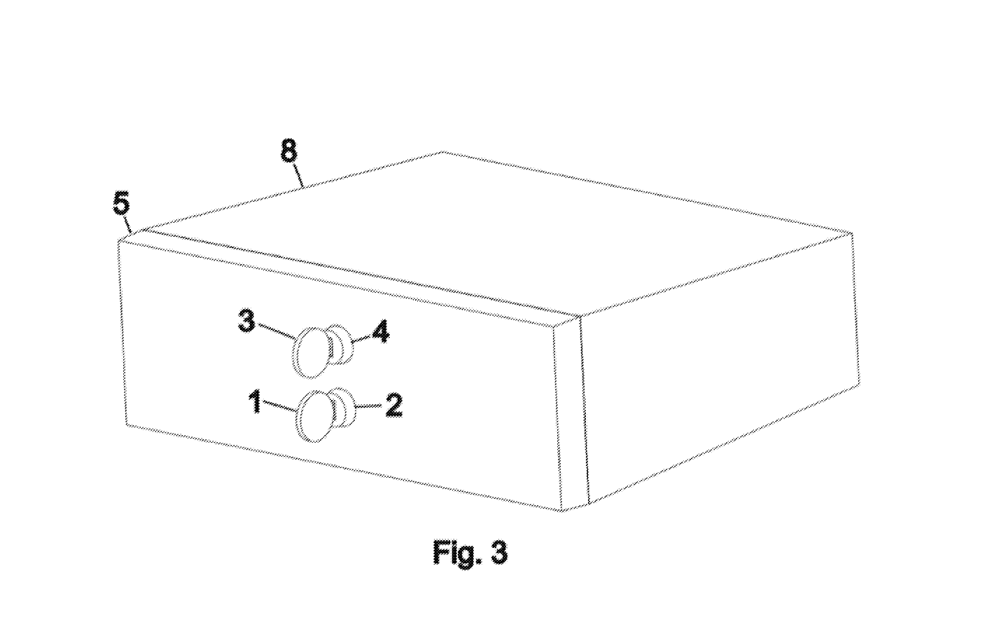

FIG. 4 shows an example of the container being opened either for placement or removal of items. Part 1 is the token key. Part 3 is the locking key. Part 5 is the lid. Part 7 is an example latch used by the locking mechanism to secure the lid. Part 8 is the main portion of the container holding the items. Part 9 indicates the hinges to the lid.

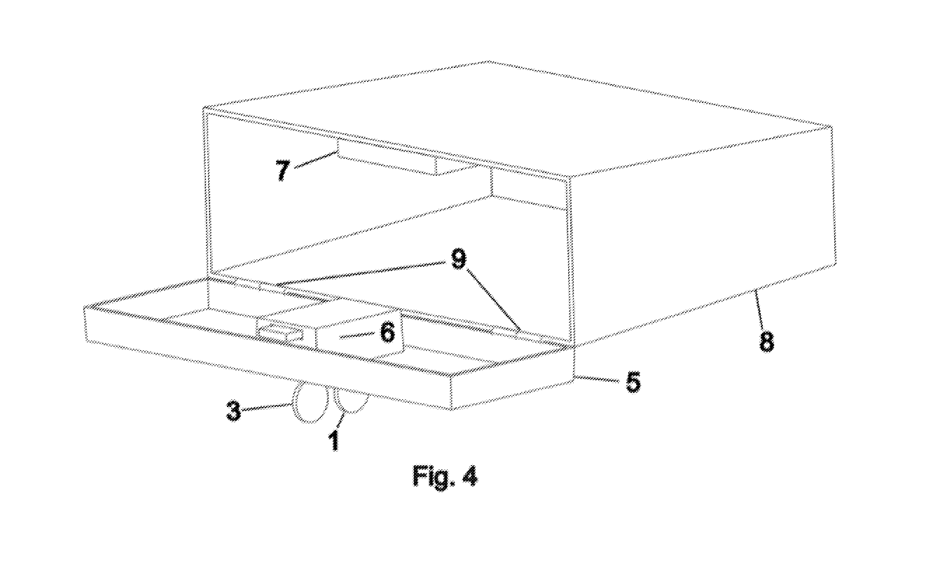

FIG. 5 shows an example of a secured container with the locking key removed and token key left in place. Part 1 is the token key. Part 2 is the token key mechanism. Part 3 is the locking key. Part 4 is the locking key mechanism. Part 5 is the lid. Part 8 is the container box.

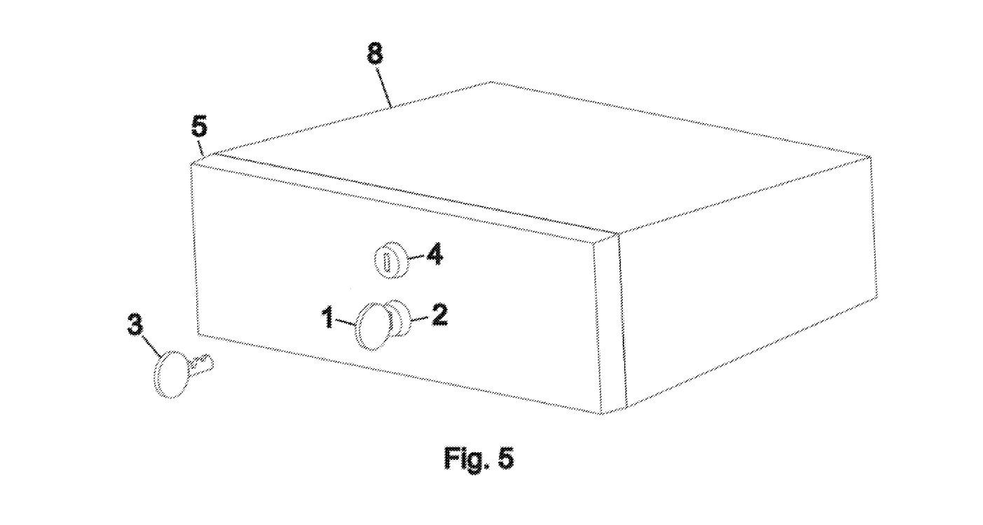

FIG. 6 illustrates the internal hardware of part 6 from the back of the mechanism, revealing its internal workings while in locked position. Part 4 is the locking key mechanism. Part 2 is the token key mechanism. Part 15 is the connector to the locking key mechanism. Part 13 is the locking pin. Part 11 is the interlink which serves to keep the locking and token key mechanisms in the relative position shown. Part 10 is the locking cam, the upper portion of which secures the lid to the latch described as part 7 on FIG. 1. The mid portion of the part 10 is secured to the locking key mechanism with the connector to the locking key mechanism. The lower portion of part 10 is connected the interlink via the locking pin. Part 16 is the connector to the token key mechanism. Part 14 is the token pin, which secures the interlink to part 12. Part 12 is the token cam, which is secured to the token lock mechanism with the connector to the token key mechanism and secured to the interlink via the token pin. Part 5 is a cutaway view of the lid shown on FIG. 4. Thus, with locking cam and token cam held in sync, the position of the locking key mechanism and token key mechanism are always held partially rotated in relation to one another. Therefore, when one key is turned to allow its removal, the other key must always be offset and not removable.

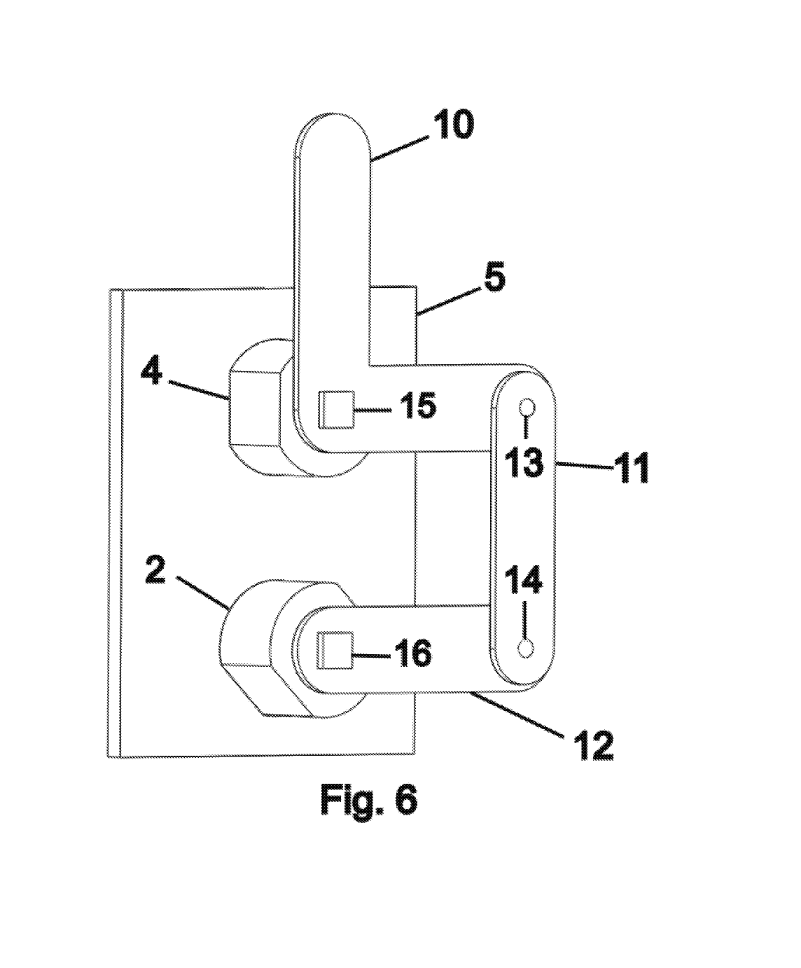

FIG. 7 illustrates the internal hardware of part 6 from the front of the mechanism while in the locked position. Part 1 is the token key. In this condition, the token key is retained while the locking key has been removed and is not shown. Part 2 is the token key mechanism shown from the front. Part 4 is the locking key mechanism shown from the front. Part 10 is the locking cam shown from the front and in locked position. Part 5 is a cutaway view of the lid face.

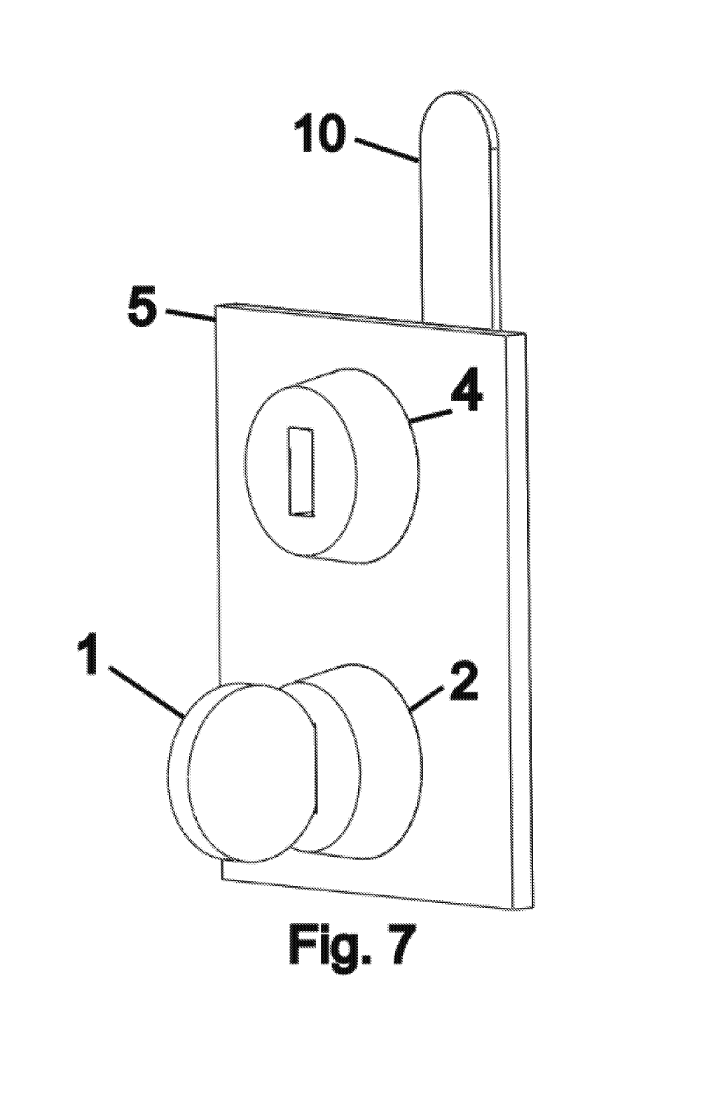

FIG. 8 illustrates the internal hardware of part 6 from the back of the mechanism while in the unlocked position. The parts described in FIG. 6 have now shifted to the unlocked position. Part 10 is the locking cam, has now rotated to a lower position where the upper portion of which will no longer catch on the latch described as part 7 on FIG. 1. The mid portion of the part 10 is secured to the locking key mechanism with the connector to the locking key mechanism. The lower portion of part 10 is connected the interlink via the locking pin. Part 16 is the connector to the token key mechanism. Part 14 is the token pin, which secures the interlink to part 12. Part 12 is the token cam, which is secured to the token lock mechanism with the connector to the token key mechanism and secured to the interlink via the token pin. Part 5 is a cutaway view of the lid shown on FIG. 4.

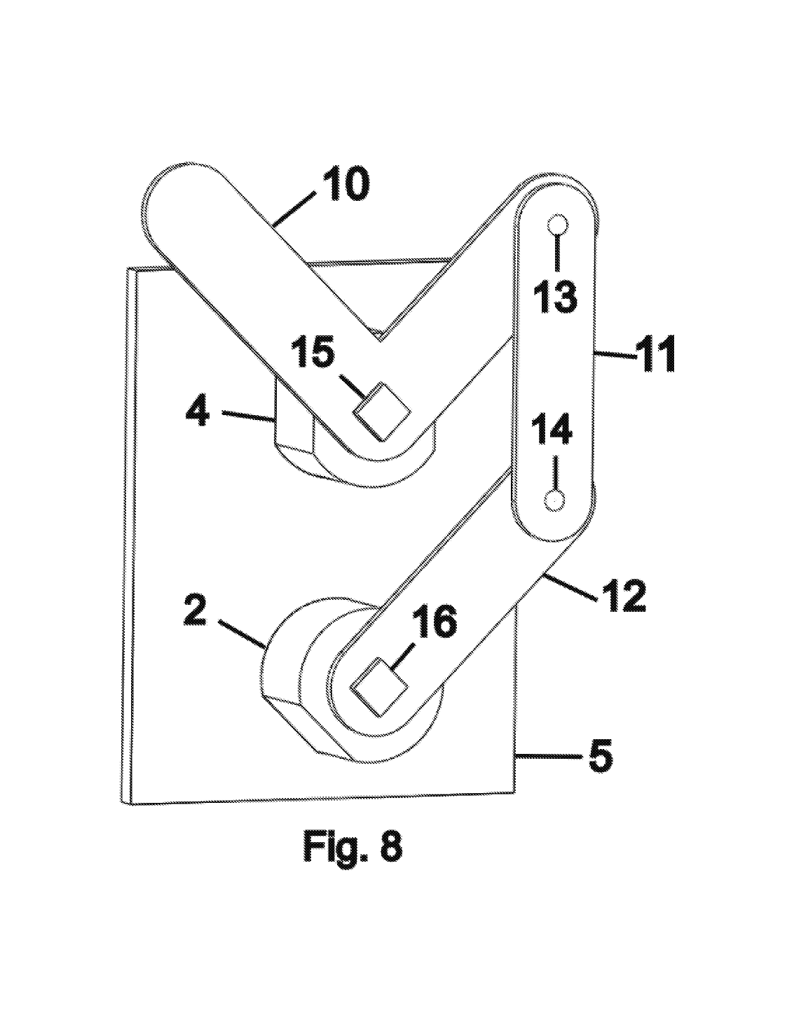

FIG. 9 illustrates the internal hardware of part 6 from the front of the mechanism while in the unlocked position. The locking key, part 3 has being retained while the token key has been removed and is not shown. Part 2 is the front of the token key mechanism. Part 4 is the front of the locking key mechanism. Part 10 is the locking cam, seen in locked position. Part 5 is a cutaway view of the lid face.

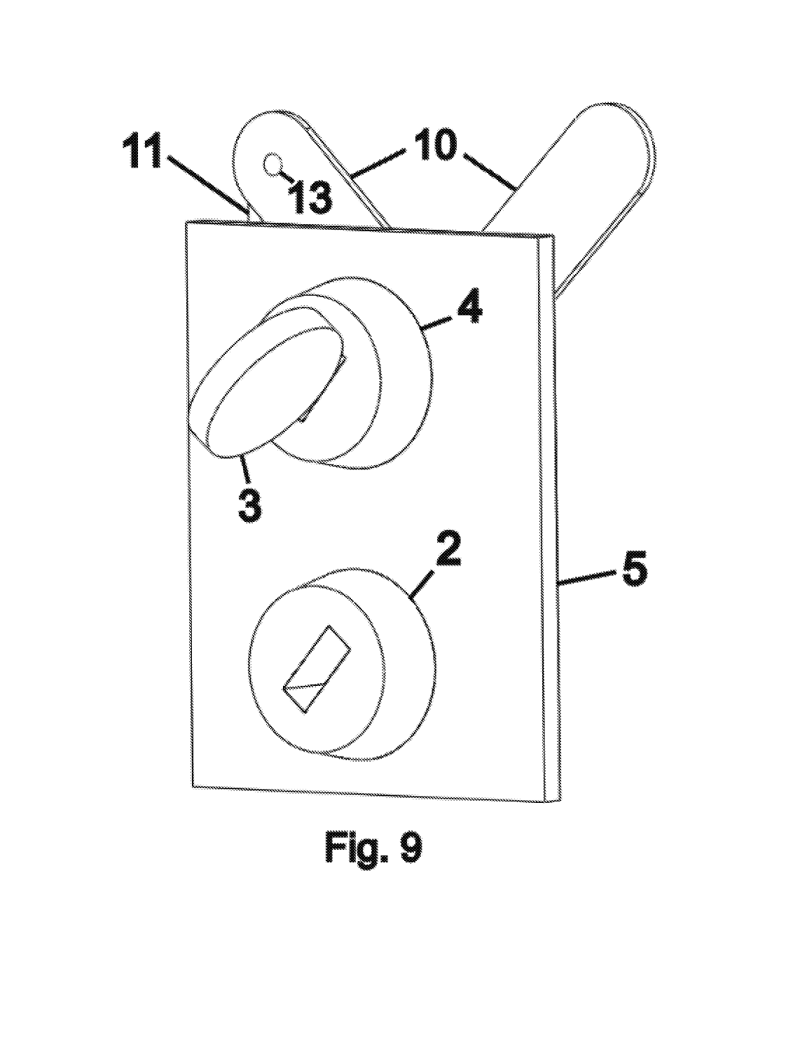

1. What is claimed is a novel method for granting access to storage lockers where a universal key is used in place of a token, retained by a unique mechanism during use of the second locking key and then returned once the locking key is replaced, thus completing the granted access.
